(19) United States
(12) Patent Application Publication
(10) Pub. No.: US 2015/0029352 A1
(43) Pub. Date: Jan. 29, 2015

(54) COLLAPSIBLE CELL PHONE BOOM ARM

(71) Applicant: Sixto Burciaga, Chula Vista, CA (US)

(72) Inventor: Sixto Burciaga, Chula Vista, CA (US)

(21) Appl. No.: 13/952,502

(22) Filed: Jul. 26, 2013

(51) Int. Cl. H04N 5/225; H04N 5/232

(52) U.S. Cl. CPC H04N 5/2251; H04N 5/23203
USPC 348/211.99; 348/376

(57) ABSTRACT

An extension arm for a digital media device having a camera communicating captured video to a viewable display, such as a smartphone, cellphone, or digital camera, is provided to extend a user's reach for media capture. The device features a telescopic member configured at a distal end to engage with the intended media device. The engagement can include a direct magnetic engagement to the media device, or employment of a protective or decorative case at the distal end of the member to engage the media device.

### FIELD OF THE INVENTION

The disclosed device relates to portable digital media devices such as smartphones, cellphones, digital cameras, and pad computers. More particularly the disclosed device relates to attachable component for such digital media devices which is configured to extended the controlled manipulation of a smart phone or the like, beyond arm's distance of the user to enhance photo capturing capability. Through an engagement of a collapsible boom arm to the smartphone or pad, using a casing or through direct contact, the smartphone may be employed for photo or video capture at a distance effectively while maintaining the engaged device portability.

### BACKGROUND OF THE INVENTION

The use and uses of digital media devices such as cell phones and smartphone devices, and pad computers, and digital cameras, has increased rapidly as their technology and functionality has expanded especially since such digital media devices all have digital cameras. The abilities of cell phones have evolved greatly beyond the original single-function communication device for the spoken word. In recent years cell phones have become small portable computing devices or smart phones, with onboard cameras and video screens, and having software and memory enabling the capturing of video and photos and editing thereof. Additional enhancements to cell phones in recent years include high energy batteries and global positioning or GPS abilities onboard.

With video, audio, and location capturing capabilities of most digital media devices, as well as the advent of multitude social applications for sharing video and data collected by smartphones and the like, consumers continue to discover ever-expanding uses for their digital media devices such as smartphone devices, or pad computers. Thus the hand held cell phone has morphed into computerized smartphones and pad computers and the like which as interaction between users increases in logarithmic fashion, have become pervasive in the daily lives of professionals as well and every day users.

For example, concert spectators having smartphones with them at such events, are now able to share their experience of watching entertainers and the crowd in real-time with their friends and family. This is accomplished by employment of the video capturing and wireless transmission of these devices. Additionally, users in supermarkets can use cell phones to read bar codes, and ascertain the local price and the price for the same item at differing locations. At gatherings, smartphone users can share their pictures for viewing for instant feedback without the requirement of internet access or a computer.

However, as smartphone functions require a user interface and user physical input or action at the point of data collection, the user's physical ability to implement the various available smartphone functions and technologies is often hampered by the user's own body and its physical limitations to remain in contact with the smartphone to run it, while straining to reach outlying positions. Photos and video and other media capture through the components of the smartphone are thus constrained by the user's height, arm's reach and arm size when attempting to capture video or photos from overhead, past an obstruction, or in small access openings or crevices with limited access.

Physically challenged users are further constrained by the height of their wheelchair, or challenges in their movements in or from the chair.

In the quest to render smartphones ever smaller for portability and easy transport, the reduced size of most cellphones and smartphones, while a blessing when in a pocket or purse, inherently limits use of the device to collect proximal audio and video recordings and photos. Thus most such smartphones are equipped with photo lenses adapted for use with the device while in the user's hand and lack optical telephoto lenses for high grade photos of more distant subjects. The same problem occurs with microphones which work well close to the device, but are not very sensitive when employed for long range capture of audio to go along with video. As a result, distant data collection is generally avoided by users since it yields poor quality media, or is just impossible to capture due to physical constraints.

Many variants of supports and tripods have been developed to increase the usability of cameras of the past. These concepts, however are not easily implemented for smartphone or cell phone use. Unlike most through the lense type cameras, cell phones and smartphones lack mounting interfaces and features. In addition, components for a rather heavy film or other camera, are unnecessarily rigid for use with lighter cell phones and smartphones. Neither are they designed with the portability and lightness desired of the cell phone engaging components. Consequently, many old fashioned reach extension components, even if they were engageable to a modern smartphone, are functionally impaired by the hindrance of carrying an external device which is larger and heavier than the cell phone itself.

As such, there exists an unmet need for a portable, collapsible, cell phone extension arm system which, can be integrated with, or can be permanently or temporarily attached to, a pre-exiting smartphone casing or surrounding case. The extension arm device may temporarily attach to a case such as with a magnet or other means for removable engagement. The device may be free standing or may employ its on connected housing for storage.

In the preferred mode the collapsed extension arm should be no longer than the cell phone or smartphone itself for each of transport. Further preferred would be such a device which engages with one or more locking or free-rotating ball joints to allow for a positioning of a viewing angle of the smart phone. Provided as an integrated case and extension assembly, the device in this mode may also contain a rotating mirror on one side of the case to increase to provide an angled viewing of the view screen of the smartphone or the like to increase its functionality. Finally, such a device should be employable with other components or accessories from a kit of such, with can be attached and detached from the end of the extension arm can be designed to further increase the extension arm's functionality.

In this respect, before explaining at least one embodiment of the cell phone extension arm invention and method herein in detail, it is to be understood that the invention is not limited in its application to the details of construction and to the arrangement of the components set forth in the following description or illustrated in the drawings nor the steps outlined in the specification. The disclosed portable, collapsible cell phone extension arm is capable of other embodiments and of being practiced and carried out in various ways as those skilled in the art will readily ascertain once educated in the novel device and method of this application.

Also, it is to be understood that the phraseology and terminology employed herein are for the purpose of description and should not be regarded as limiting in any manner. As such, those skilled in the art will appreciate that the conception upon which this disclosure is based may readily be utilized as a basis for designing other methods and systems for carrying out the several purposes of the collapsible cell phone boom arm device disclosed herein. It is important, therefore, that the claims be regarded as including such equivalent construction insofar as they do not depart from the spirit and scope of the present invention.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

### OBJECTS OF THE INVENTION

The device and system herein disclosed and described provides a solution to the shortcomings in prior art and achieves the above noted goals through the provision of a device and system for extending ability for employment of smartphone media capture ability, beyond arms reach of the user, and thus increasing the functionality and uses for smart phones and media-capturing cell phones and other electronic devices.

In accordance with the one preferred mode of the device, the cell phone extension arm and cell phone case are an integrated unit. So integrated, the extension arm is rotatably engaged through a rotating ball joint to a surface such as the top or bottom corners of the case's side walls. So engaged, the arm can fully collapse by one side surface of the cell phone or smartphone without increasing the length of case's footprint.

The elongating extension is formed from at least two telescoping nesting members which are rigid enough to bear the cantilevered weight of the case and phone in its extended configuration. The members are formed to also maintain a minimum thickness and therefor weight, to reduce bulk and overall assembly width and weight of the device. The extension arm can include fasteners or clamps or other means for maintaining the telescopic members positioned, to prevent the extension from collapsing or expanding unintentionally.

Clips on, or attached to, the phone case can also be employed to ensure that the extension does not unintentionally rotate away from smartphone case when not in use. Using existing bluetooth cell phone or smartphone enabled remote controls, or using wired connection threaded along the extension arm, provides a means for remote control to allow the user to trigger the action required of the positioned smartphone from the proximal end of the extension arm.

Particularly preferred, a mirror can be engaged to the cell phone or smartphone engaging case for use as a standing mirror when propped up using a support member. If the mirror is designed to be double-sided, or rotate to hinge about the edge of the viewing screen for the camera of the smartphone, it can also provide the user to view a means to view the field of view of the camera while extended on the support member, from the proximal end of the arm in their hand. The case, joint or engagement and extension arm can be formed from any material or combination of materials suitable for the purposes set forth in this disclosure.

In an alternative preferred mode, the cell phone extension arm can be designed as a peripheral device, which can attach permanently to an existing case, or temporarily to a specialized or modified smartphone or cell phone case. In this mode the device herein can be permanently attached to an off-the-shelf cell phone or smartphone protective case via glue, epoxy, or a mechanical fastener designed to securely engage the case. A cell phone or smartphone case designed specifically for repeated attachment and detachment of a extension arm herein can employ fixed or removable means for engagement such as points or strips or polar magnets, mating mechanical fasteners, or dovetail cooperative fastening features which would allow the extension assembly to slide and lock into the case.

The extension arm may contain its own housing features for ease of storage when detached. Although this mode allows the user to disconnect the extension arm when not in use, so as to reduce the bulk and weight of the smartphone or cellphone when the device is not needed.

Several modes may be employed for operation of the ball joint style engagement, which connects the extension arm permanently or temporarily to the protective case or the cell phone casing. So engaged at the distal end of the extension arm, the means for rotational engagement allows the engaged phone, smartphone, or digital camera or the like, to pitch, roll and yaw about the axis of the extension arm.

In use, this allows the user a means to position the camera, phone, or smartphone, to capture video in the viewing screen and memory, from various viewing planes unconstrained by the axis of the user's arm, or the extension arm. The user will thus turn on the video recorder and extend the arm to capture audio and video, or can set a timer for the camera to capture a photo after the arm is extended and positioned.

The ball joints can be adapted with sufficient frictional engagement, or with a suitable locking mechanism, or both, to allow for a positioning of the angle of the lens view of the smartphone for the purpose at hand, and thereafter prevent gravity, or any angular momentum, from accidentally jarring the preset angle of view of the camera or phone or the like. It is advantageous to provide such a locking mechanism to allow the assembly to function as a stable cell phone stand, when the collapsed extension arm is rotated behind the phone and hold the video screen or camera lens at user positioned angle. Two connected ball joints can also be implemented for further articulation.

In addition, many designs can be conceived for end connector accessories to increase the extension arm's functionality, which can attach and detach to the end of the extension arm via any one or multiple combinations of available fastener, magnet or mechanisms. The accessories could include one or a combination of any hook, clip, magnet or fasteners to allow the cell phone extension arm to hang or adhere to other surfaces. Particularly preferred is the provision of an engaged or engageable female threaded assembly, sized for engagement with the threaded end of a conventional broom handle, or painting arm, or existing industrial extension arms. Engagement of this threaded receiving assembly allows the camera or smartphone or cell phone or the like, to operatively engage upon the distal end of such a threaded extension arm. Another preferred attachment, all of which may be provided in a kit of interface attachments, is an accessory which includes a ¼-20 UNC bolt which allows the extension arm, to attach to a standard camera tripod at a proximal end and position the camera or smartphone on the other end.

With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

It is an object of the present invention to extend the distance from their hands, at which the user can operate their cell phone, smart phone.

It is another object of the disclosed device is to provide a support to angularly position the display of a smartphone or camera or the like, vertically from a horizontal support surface.

An additional object of the invention is to allow the cellphone or smartphone or other protective case to attach to the extension arm or other devices and surfaces via one or a combination of magnets, fasteners or mechanisms which may be provided in a kit.

It is an additional object of such a device to not only extend the media capture distance for a user of the smartphone or device, but to also provide a means for extending the user view of a display screen which may position angularly out of view, through the providing of user-angled mirrors.

These and other objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF DRAWING FIGURES

The accompanying drawings, which are incorporated herein and form a part of the specification, illustrate some, but not the only or exclusive, examples of embodiments and/or features. It is intended that the embodiments and figures disclosed herein are to be considered illustrative of the invention herein, rather than limiting. In the drawings:

FIG. 1 shows the front view of the first mode device where the extension arm is in a collapsed position and in its storage location.

FIG. 2 shows the side view of FIG. 1.

FIG. 3 shows a shows an isometric view of the device if FIG. 1 with the extension arm in an extended position.

FIG. 4 shows the delineations of the second preferred mode, where the extension arm is separable.

FIG. 5 depicts possible extension arm constraints.

FIG. 6 shows the device in the propped phone position.

FIG. 7 shows the device in the propped mirror configuration.

FIG. 8 shows user positionable case mirror for viewing an out of view video display from a distance.

FIG. 9 shows the end connector accessory.

FIG. 10 shows a removably engageable integrated extension storage enclosure.

FIG. 11 depicts a magnetically engageable surface positionable upon an OEM phone or smartphone casing, or the engageable case herein.

FIG. 12 shows an extension arm having a removable engagement to the case or casing and also showing a wired remote control.

FIG. 13 is a view of a removably or permanently engageable housing having a magnet tipped extension arm therein.

FIG. 14 depicts the device of FIG. 13 with housing engaged and extendable arm at an angled positioning.

### DETAILED DESCRIPTION OF THE INVENTION

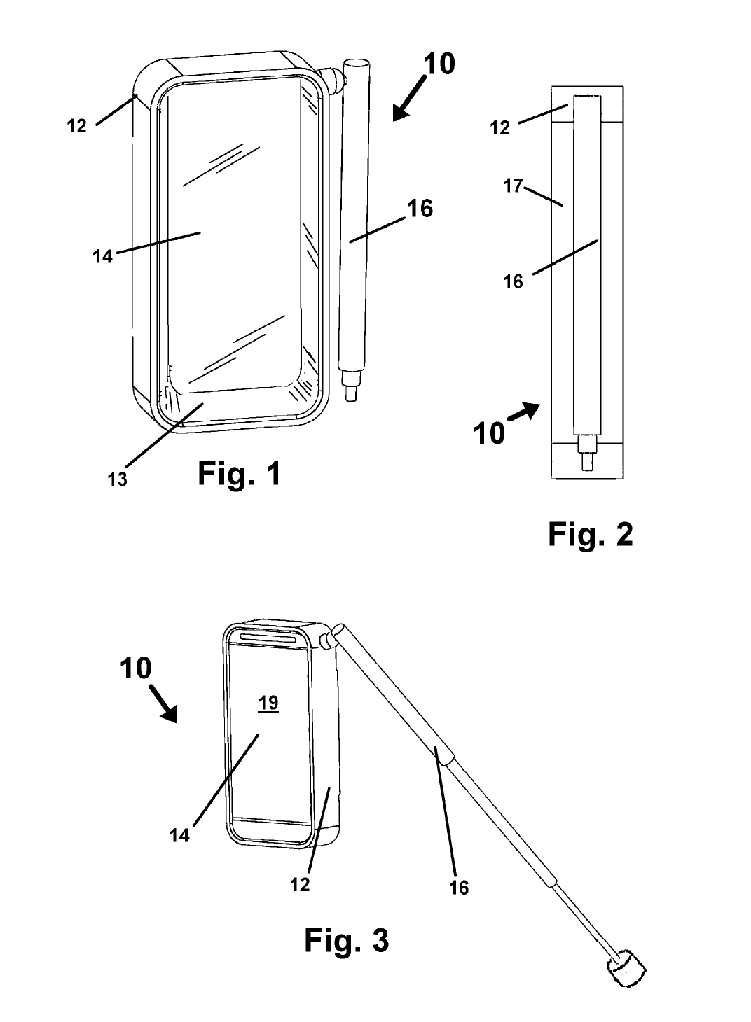

Now referring to drawings in FIGS. 1-14, wherein similar components are identified by like reference numerals, there is seen in FIG. 1, FIG. 2, and FIG. 3, respective views of a first particularly preferred mode of the device 10 employing an extension arm 16 which may be permanently or removably engaged to the case 12 which is adapted for a frictional engagement with the exterior of a smartphone or cellphone or camera herein referred to as phone 14. The telescopic arm 16 may also be spring-loaded or motorized to automatically translate to the extended length and back. As noted in various modes the extension arm 16 may be fixed in engagement to the case 12 or employ means for removable engagement of the distal end of the arm 16 to the case 12.

As shown in FIG. 1, where the device 10 is in a stored position with collapsed extension arm 16, the case 12 is empty and has an internal cavity 13 sized for a surrounding engagement upon the exterior of a smartphone or cell phone or camera herein phone 14.

As shown in FIG. 3, the case 12 is operatively engaged with a phone 14 by positioning the phone 14 within the internal cavity 13. Such cases 12 conventionally provide internal cavities 13 and engageable access thereto, to allow a user to place the case 12 in an operative engagement to a phone 14 and any such engagement and case 12 is considered in the scope of this patent.

Once operatively engaged, the cell phone extension arm 16 and cell phone case 12 function as an integrated assembly with the operatively positioned phone 14 within the internal cavity 13. So engaged, the case 12 serves to protect and constrain the phone 14 and maintain it in operative positioning adjacent the distal end of the extension arm 16.

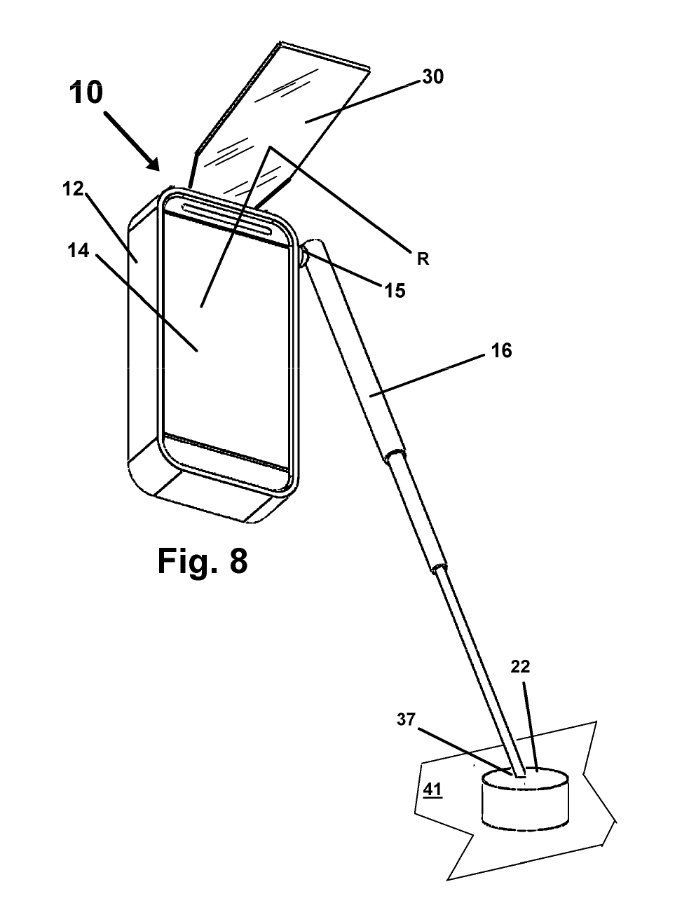

As shown in FIGS. 1-3, the case 12 is engaged at or adjacent to the distal end of the extension arm 16, preferably with a means for rotatable engagement to angled positions relative to the axis of the extension arm 16. A hemispherically rotatable ball joint 15 is shown having a first mount on the case 12 and second mount on the distal end of the extension arm 16 and a hemispheric rotational engagement therebetween. The rotating ball joint 15 is shown at preferred mounting points at the top or bottom corners of the sidewalls 17 of the case 12, which allows room for the extension arm 16 to fully collapse adjacent the side of the phone 14 without increasing the length of case 12 footprint. However, other positions could be used to mount the ball joint 15 to the case 12 if desired. This hemispheric rotating ball joint 15 allows the user to angle the camera, cellphone, smartphone, or similar devices herein phone 14 to position the lens thereof to capture video for storage, play, or transmission. A positionable mirror 30 as shown in FIG. 8, when properly user positioned, reflects the depiction of the camera view on a video display 19 to allow a viewing by a user at the proximal end of the elongated extension arm 16 when the display 19 is at an angle which is un viewable or out of the line of sight of the user. Such positions generally occur when the plane of the display 19 is normal or perpendicular or otherwise angled out of view or in poor viewing position, relative to an imaginary line running across the front of the user's two eyes.

In use, the user will either turn on the video recorder of the digital media device such as a smartphone, cellphone, or camera, and extend the arm 16 from a collapsed position to its elongated extended position. With video running the user can capture and store the desired video recording or photo. Alternatively, the user will set a timer for the digital media device to take one or a plurality of photos at a time when the arm 16 is extended and the camera portion of the digital media device is properly positioned which can be confirmed by viewing the mirror.

The extension arm 16 is formed from a plurality of telescopically engaged smaller hollow members each of which is rigid enough to bear the cantilevered weight of the assembly formed by the case 12 and operatively engaged phone 14 in an extended configuration such as FIG. 3, while preferably maintaining a minimum thickness and weight, to reduce bulk and overall assembly width. The case 12, joint and extension arm 16 can be formed from any material or combination of materials suitable for the purposes set forth in this disclosure.

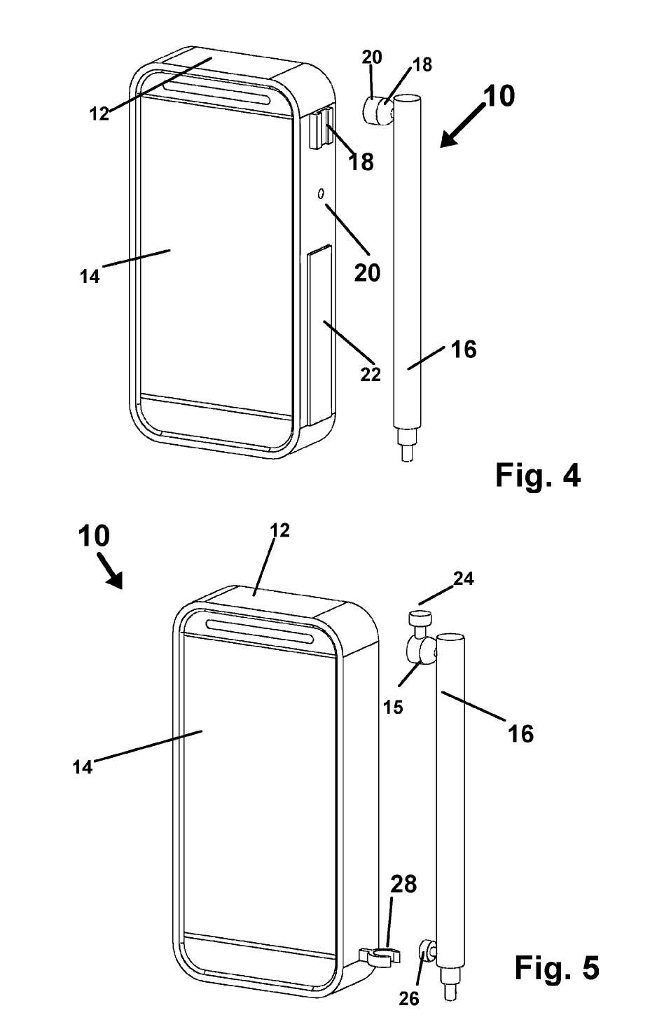

In another preferred mode of the device 10 herein, the cell phone extension arm 16 is configured for removable engagement to an existing phone casing or protective case 12 such as in FIGS. 4-5 and 12-13, using an attachable mating fastener to engage with a complimentary fastener at the distal end of the extension arm 16.

The extension arm 16 can be permanently attached to an off-the-shelf cell phone, or protective case 12 therefore, using adhesive to fuse with the case 12 or phone, or a mechanical, fastener, such as a screw or g designed to penetrate the sidewall defining the case 12 such as in FIGS. 5-9.

A cell phone case 12 designed specifically for a removable engagement of a extension arm 16 can be configured as in FIG. 5. Such a means for removable engagement 21 of the case 12 to or at the distal end of the arm 16 can employ points or strips of polar-attracting magnets 22 on the case 12 and arm 16 or mating mechanical fasteners 20, or dovetail engaging components 18 which would allow the extension assembly to slide and lock into the case. The extension arm 16 may contain its own housing features for ease of storage when detached such as in FIGS. 10 and 13-14.

To allow for user positioning, shown in FIG. 5, ball joints 15 can be configured with sufficient frictional restraint, or a suitable ball joint locking mechanism 24 can be implemented to substantially fix the desired angle of the case 12 and contained phone 14 or other device, to prevent gravity, or angular momentum from changing the case 12 and phone 14 angular position relative to the axis of the member 16.

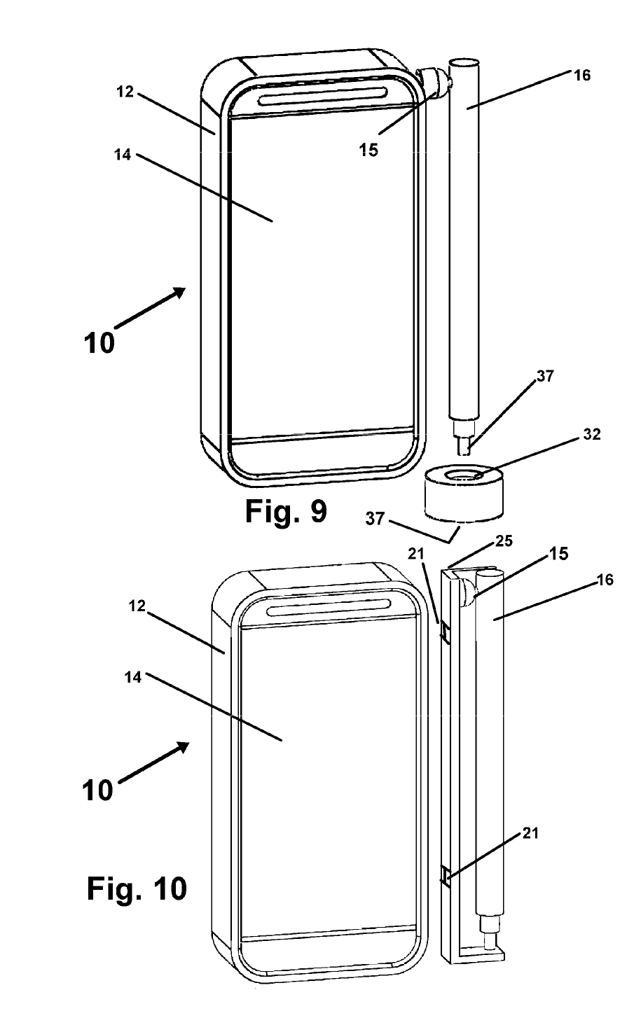

To maintain the stored or retracted position of FIG. 1 or 9, the ball joint locking mechanism 24 such as a twistable variable translation pressure contact device, or an extension arm clip 28, can also serve to constrain the cell phone extension arm 16 adjacent the cell phone case 12 sidewall 17.

Employment of the extension locking mechanism 26, provides a means to maintain the extension arm 16 in a set extended length and allows the user to lock the extension of the cell phone extension arm 16 to prevent unintended collapse.

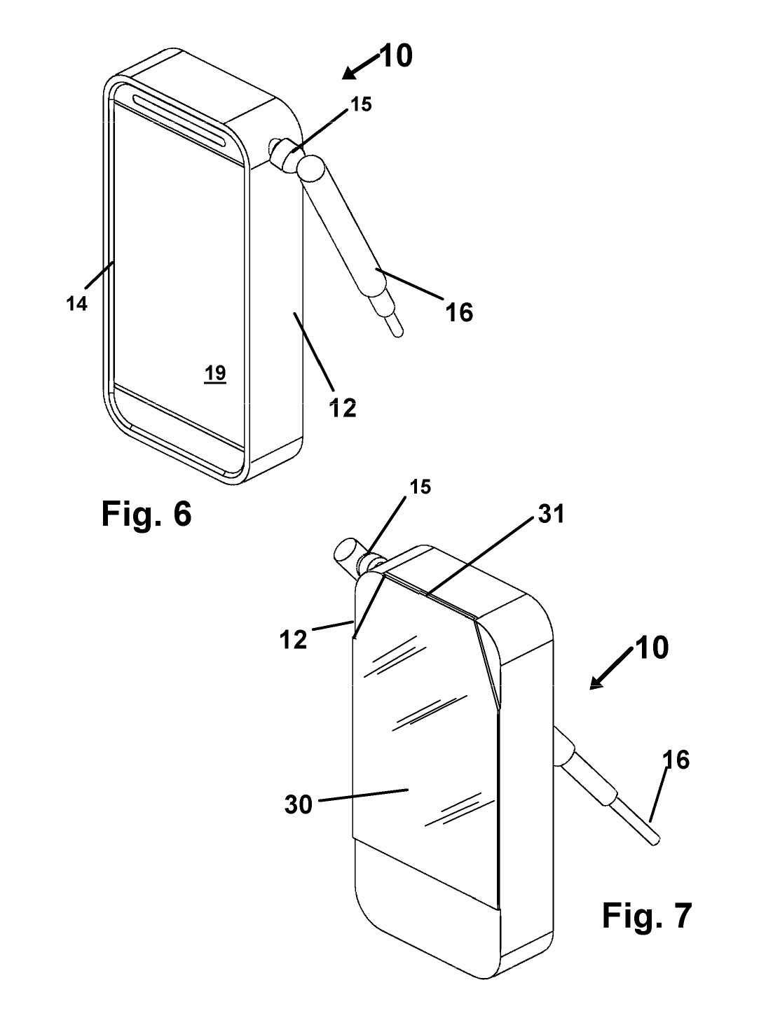

Such extension and rotation locking mechanisms 24, 26 and 28, can allow the assembly to function as a stable cell phone stand such as in FIG. 6, when the collapsed extension arm is rotated behind the case 12 per FIG. 6.

Particularly preferred in all modes of the device 10 is the provision or a mirror 30. For use for make up or other mirror 30 uses, it may be affixed to the cell phone case 12, opposite the side of the display 19, and can allow the assembly to function as a propped mirror per FIG. 7.

The mirror 30 may also be designed to be double-sided, or may be of sufficient length and configuration to rotate on a hinge 31 from a first position adjacent the rear surface opposite the display 19, to a second position, angled to the display 19 to provide a means for reflecting “R” the display 19 and the camera view if shown thereon, to a viewable angle by the user when the plane of the display 19, is out of the user's view, or at an angle difficult to see. So positioned, with the device 10 and phone in an elevated position, the mirror 30 provides a means for reflecting the video screen of the phone's camera, such that it allows the user to view the scene being captured by the lens, upon the cell phone's display 19 in real time. This provides a means for the user to use their eyesight to frame and shoot the desired shot using the camera of the phone 14, correctly while the arm 16 is in the extended position with the phone 14 positioned with the display 19 in an un viewable or poorly viewable plane relative to the user's line of sight. The mirror 30 might also be rotatably engaged with or to the telescopic member 16.

The device 10 can be provided with one or a plurality of end connectors 32 that serve as a mount for the arm 16 such as in a kit thereof. Shown in FIGS. 8 and 9, such end connectors 32 can be provided to interface with the proximal end of the arm 16 and engage conventional threaded sticks and handles, to increase the extension arm's 16 functionality, or to provide a stable magnetic mount to a magnetically attractive surface. The connecters 32 are configured to engage on one end with the mounting surface or rod or stick or the like. The connectors 32 on the opposite side are configured to attach and detach to the distal end of the extension arm 16 such as with a threaded engagement 37 between the two as shown in FIG. 8 where the connector is a magnet 22 holding the case 12 elevated on the arm 16 from a magnetic engagement to a mounting surface 41. Of course other fastening means as would occur to those skilled in the art, to removably engage the connectors 32, to the arm 16 may be employed and are anticipated within the scope of this patent.

The opposite side of the connector 32 from the arm engagement, can ends with a hook, clip, magnet or mating connections or fasteners to allow the cell phone extension arm to hang or adhere to other surfaces or members.

Particularly preferred is the inclusion of a threaded recess 39, configured for threaded engagement to the threaded end of conventional broom handles or existing industrial extension arms such as with a ¾″ outer thread dia×5 TPI or with a 1.080″ outer thread dia×4 TPI. This interface between the arm 16 means for attachment of the threaded end of a conventional broom handle or painting extension rod, to the proximal end of the arm 16. Such a threaded recess can include a ¼-20 UNC threaded recess as a means for engaging the the cell phone extension arm 16 to a standard camera tripod screw fitting.

Shown in FIG. 10 is a removably engageable housing 25 with the elongated member 16 engaged thereto. Means for removable engagement 21 may be provided such as adhesive, hook and loop fabric, magnets, mechanical mating fasteners, or the like, to provide for attachment of the housing 25 and member 16 as a unit.

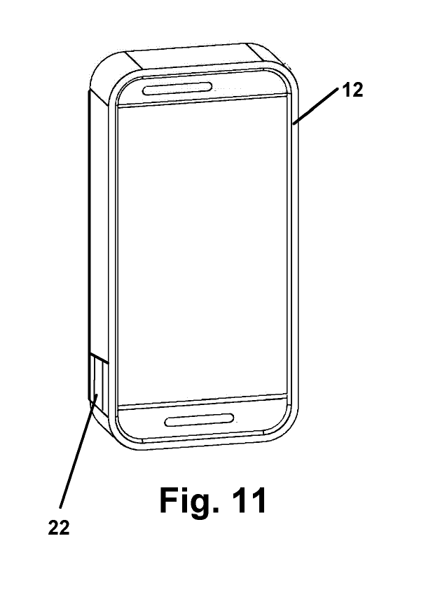

FIG. 11 depicts another means for removable engagement of housings 25 or the ball joint 15 to engage the distal end of the member 16 to the phone 14 or the case 12.

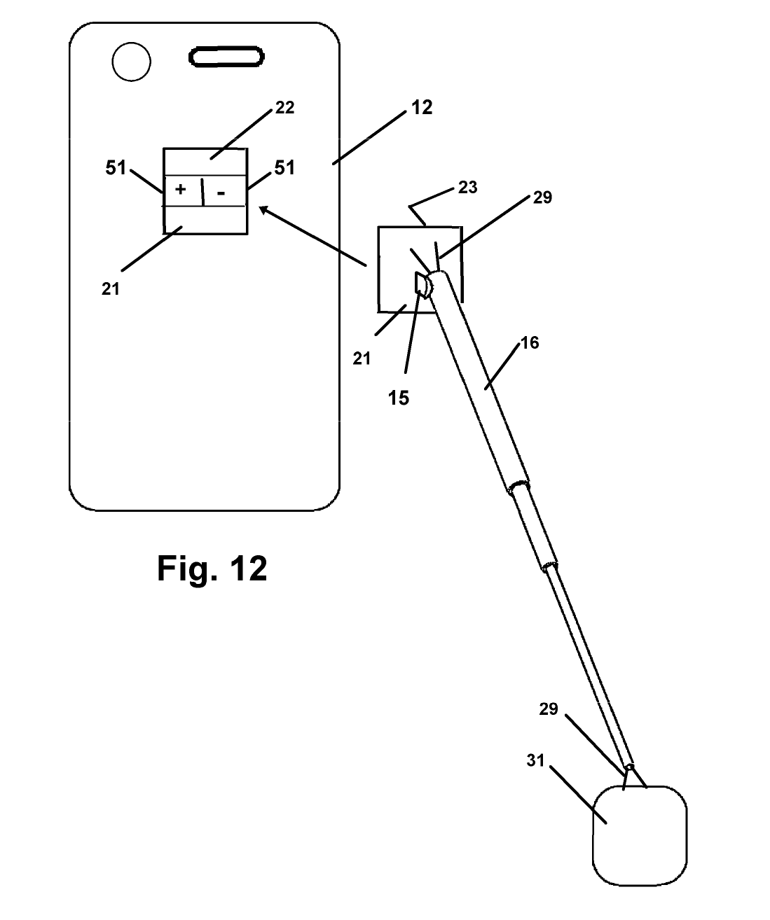

FIG. 12 shows a very easy to employ mode of the device 10 to employ and engage it upon either a case 12 or a phone 14 itself. The extension arm 16 has means for removable engagement to a sidewall or rear wall of the case 12, or to a phone 14 which might also be employed without a case 12. Magnets 22 are positioned on the case 12 or a phone 14 surface positioned for engagement to mating attractive magnets 23, on the distal end of the member 16. This mode can easily be incorporated into new OEM phones 14 by positioning the magnet 22 mount thereon to mate with the attracting magnet 23 of the member 16. Or phones 14 may be retrofitted with adhesive engaged magnets 22. Or as noted, the magnet 22 can be placed on an existing or new protective case 12. This engagement mode of the member 16 to a phone 14, or a new or existing case 12 can be widely and quickly deployed for use.

Also shown in FIG. 12 are axially positioned wire or wires 29 which provide communication of an electric signal from remote control 31 to the phone 14 which as noted may be a smartphone, cell phone, camera or other device. Or, the wires 29 can be employed to communicate charging power through power connectors 51 on the phone 14 or on the case 12 and communicating power to the phone 14. A power source will be engaged at the opposite end of the wires 29 from the attractive magnets 23 or magnetically attractive surface for the magnets 22. If the shown wires 29 or additional wires 29 axially located are used for bluetooth or other remote control actions, control communications are electronic by providing a carrier for RF communication to the case 12 enclosed phone 14, or by hardwire communication of input signals from the remote control 31 operatively configured for such.

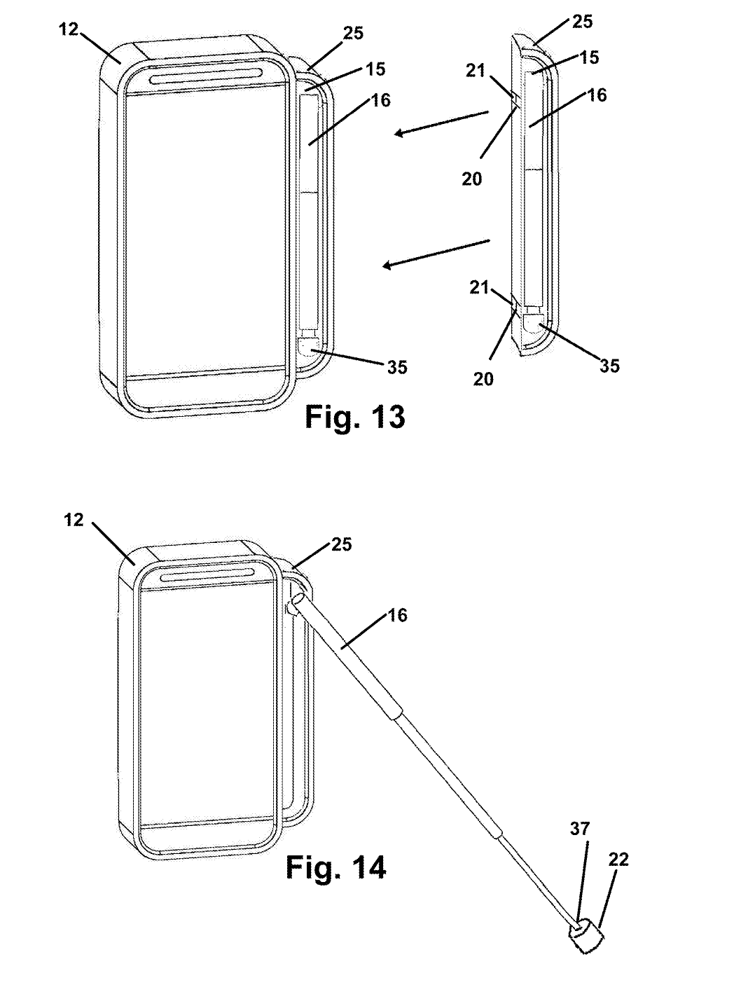

In FIG. 13 is a view of a removably or permanently engageable housing 25 similar to that in FIG. 10 and having a magnet tipped extension arm 16 therein. Removable means for engagement 21 or permanent engagement may be employed to engage the housing to the case 12. A view of the device of FIG. 13 with the member 16 extended with the magnetic tip 22 thereon is shown in FIG. 14.

As noted above, while the present invention has been described herein with reference to particular embodiments thereof and steps in the method of production, a latitude of modifications, various changes and substitutions are intended in the foregoing disclosures, it will be appreciated that in some instance some features or steps in formation of the invention could be employed without a corresponding use of other features without departing from the scope of the invention as set forth in the following claims. All such changes, alternations and modifications as would occur to those skilled in the art are considered to be within the scope of this invention as broadly defined in the appended claims.

Further, the purpose of any abstract of this specification is to enable the U.S. Patent and Trademark Office, the public generally, and especially the scientists, engineers, and practitioners in the art who are not familiar with patent or legal terms or phraseology, to determine quickly from a cursory inspection the nature and essence of the technical disclosure of the application. Any such abstract is neither intended to define the invention of the application, which is measured by the claims, nor is it intended to be limiting, as to the scope of the invention in any way.

What is claimed is:

1. An extension arm for a digital media device having a camera communicating captured video to a viewable display, such as a smartphone, cellphone, or digital camera, comprising:
a telescopic member having a distal end and a proximal end;
means for engagement of said digital media device, to an attached position, adjacent said distal end of said telescopic member;
said proximal end adapted for engagement with a mount or for gripping by the hand of a user;
said telescopic member translatable from a collapsed position to an extended position; and
said telescopic member in said extended position, with said proximal end being gripped by said user, providing a means holding said digital media device a distance from said user's body for obtaining said captured video while supported by said telescopic member.

2. The extension arm of claim 1, wherein said means for engagement of said digital media device, to an attached position comprises:
a first magnet located at or adjacent said distal end of said telescopic member; and
a second magnet, or magnetically attractive surface to said first magnet, engaged with or to said digital media device, whereby said digital media device is magnetically engageable to said telescopic member.

3. The extension arm of claim 1, wherein said means for engagement of said digital media device, to an attached position comprises:
a case having sidewalls defining an internal cavity;
means for engagement of said case at or adjacent to said distal end of said telescopic member; and
said internal cavity configured for a surrounding engagement of an exterior surface of said digital media device.

4. The extension arm of claim 1 additionally comprising:
a mirror rotationally engaged with one of said digital media device or said telescopic member adjacent said distal end;
said mirror rotatable to an angled position relative to a plane running across a surface of said display; and
said angled position reflecting said captured video communicated to said display, in a reflection viewable by said user at or adjacent said proximal end of said telescopic member.

5. The extension arm of claim 2 additionally comprising:
a mirror rotationally engaged with one of said digital media device or said telescopic member adjacent said distal end;
said mirror rotatable to an angled position relative to a plane running across a surface of said display; and
said angled position reflecting said captured video communicated to said display, in a reflection viewable by said user at or adjacent said proximal end of said telescopic member.

6. The extension arm of claim 3 additionally comprising:
a mirror rotationally engaged with one of said case or said telescopic member adjacent said distal end;
said mirror rotatable to an angled position relative to a plane running across a surface of said display; and
said angled position reflecting said captured video communicated to said display, in a reflection viewable by said user at or adjacent said proximal end of said telescopic member.

7. The extension arm of claim 1 additionally comprising:
a hemispherically rotatable engagement between said digital media device and said telescopic member.

8. The extension arm of claim 2 additionally comprising:
a hemispherically rotatable engagement between said digital media device and said telescopic member.

9. The extension arm of claim 3 additionally comprising:
a hemispherically rotatable engagement between said case and said telescopic member.

10. The extension arm of claim 4 additionally comprising:
a hemispherically rotatable engagement between said case and said telescopic member.

11. The extension arm of claim 5 additionally comprising:
a hemispherically rotatable engagement between said case and said telescopic member.

12. The extension arm of claim 6 additionally comprising:
a hemispherically rotatable engagement between said case and said telescopic member.

13. The extension arm of claim 1, additionally comprising:
an axial cavity communicating through said telescopic member;
wired communication communicating through said axial cavity from one or both of a remote control and an electrical power source; and
whereby engagement of said telescopic member operatively engages one or both of said remote control and said electrical power source in an operative engagement with said phone.

14. The extension arm of claim 2, additionally comprising:
an axial cavity communicating through said telescopic member;
wired communication communicating through said axial cavity from one or both of a remote control and an electrical power source; and
whereby engagement of said telescopic member operatively engages one or both of said remote control and said electrical power source in an operative engagement with said phone.

15. The extension arm of claim 11, additionally comprising:
an axial cavity communicating through said telescopic member;
wired communication communicating through said axial cavity from one or both of a remote control and an electrical power source; and
whereby engagement of said telescopic member operatively engages one or both of said remote control and said electrical power source in an operative engagement with said phone.
